(19) United States
(12) Patent Application Publication
(10) Pub. No.: US 2018/0330375 A1
(43) Pub. Date: Nov. 15, 2018

(54) METHOD AND SYSTEM FOR AUTHORISING TRANSACTIONS

(71) Applicant: Mastercard International Incorporated, Purchase, NY (US)

(72) Inventor: Piyush Sharma, Pune (IN)

(73) Assignee: Mastercard International Incorporated, Purchase, NY (US)

(21) Appl. No.: 15/967,177

(22) Filed: Apr. 30, 2018

(30) Foreign Application Priority Data
May 11, 2017 (SG) 10201703863X

(51) Int. Cl. G06Q 20/40; G06Q 20/10; G06Q 20/20

(52) U.S. Cl. CPC G06Q 20/4012; G06Q 2220/00; G06Q 20/20; G06Q 20/1085

(57) ABSTRACT

A computer-implemented method and a system for authorising transactions, the computer-implemented method including: receiving, from an electronic device, a transaction request, the transaction request including date of birth (DOB) information, an account identification code (AIC), and a personal identification number (PIN); identifying a primary account number (PAN) associated with an account based on the DOB information and the AIC; sending an authorisation request including the PIN to an issuer server associated with the issuer of the account; receiving an authorisation approval from the issuer server; and sending a transaction approval to the electronic device based on the authorisation approval.

### CROSS-REFERENCE TO RELATED APPLICATIONS

This application claims the priority of Singapore Application Serial No. 10201703863X, filed May 11, 2017, which is incorporated herein by reference in its entirety.

### TECHNICAL FIELD

The present disclosure relates to a computer-implemented method and a system for authorising transactions, including in one or more examples, to a computer-implemented method and a system for authorising transactions conducted at an automated teller machine (ATM) or a point-of-sale (POS) machine.

### BACKGROUND

The reference in this specification to any prior publication (or information derived from it), or to any matter which is known, is not, and should not be taken as an acknowledgment or admission or any form of suggestion that the prior publication (or information derived from it) or known matter forms part of the common general knowledge in the field of endeavour to which this specification relates.

A payment card issued to a cardholder of a financial institution can be a convenient and portable tool for accessing the cardholder's financial account with the financial institution, and conducting transactions. For example, a debit card or credit card may be used at a terminal device, such as an ATM or a POS machine, for authorising transactions such as bill/fee payment, cash withdrawal, cash deposit or fund transfer.

However, in order to conduct a transaction at an ATM or a POS machine, typically the cardholder is required to carry the actual card to the ATM or the POS machine, which not only is burdensome to the cardholder, but may also lead to the risk of losing the card or forgetting the card at the ATM or the POS machine after the transaction is completed, thereby decreasing the security of the use of the card.

Alternatives to using physical cards at ATMs or POS machines may exist. For example, some authorisation methods may allow the use of the number of a financial card together with a preselected password such as a personal identification number (PIN). However, the number of a financial card typically includes 13 to 16 digits, and usually appears non-logical and random to a user, thus may cause difficulty for the user to remember it correctly and input it accurately in use.

Therefore, an easier alternative to access a user account without using a physical card may be desired.

It is desired to address or ameliorate one or more disadvantages or limitations associated with the prior art, or to at least provide a useful alternative.

### SUMMARY

In one aspect, there is provided a computer-implemented method for authorising transactions, including: receiving, from an electronic device, a transaction request, the transaction request including date of birth (DOB) information, an account identification code (AIC), and a personal identification number (PIN); identifying, based on the DOB information and the AIC, a permanent primary account number (PAN) associated with an account; sending an authorisation request including the PIN and the PAN to an issuer server associated with the PAN; receiving an authorisation approval from the issuer server; and sending a transaction approval to the electronic device based on the authorisation approval.

In a second aspect, there is provided a system for authorising transactions, the system including at least one processor configured to: receive, from an electronic device, a transaction request, the transaction request including date of birth (DOB) information, an account identification code (AIC), and a personal identification number (PIN); identify, based on the DOB information and the AIC, a primary account number (PAN) associated with an account; send an authorisation request including the PIN and the PAN to an issuer server associated with the PAN; receive an authorisation approval from the issuer server; and send a transaction approval to the electronic device based on the authorisation approval.

There is also provided at least one non-transitory computer-readable storage media having computer-executable instructions embodied thereon for authorising transactions, wherein when executed by at least one processor, the computer-executable instructions cause the processor to: receive, from an electronic device, a transaction request, the transaction request including date of birth (DOB) information, an account identification code (AIC), and a personal identification number (PIN); identify, based on the DOB information and the AIC, a primary account number (PAN) associated with an account; send an authorisation request including the PIN and the PAN to an issuer server associated with the PAN; receive an authorisation approval from the issuer server; and send a transaction approval to the electronic device based on the authorisation approval.

In a further aspect, there is provided a computer-implemented method for authorising transactions, including: receiving, from an electronic device, a transaction request, the transaction request including predetermined personal information (PPI), an account identification code (AIC), and a personal identification number (PIN); identifying, based on the PPI and the AIC, a primary account number (PAN) associated with an account; sending an authorisation request including the PIN and the PAN to an issuer server associated with the PAN; receiving an authorisation approval from the issuer server; and sending a transaction approval to the electronic device based on the authorisation approval.

There is also provided a system for authorising transactions, the system including at least one processor configured to: receive, from an electronic device, a transaction request, the transaction request including predetermined personal information (PPI), an account identification code (AIC), and a personal identification number (PIN); identify, based on the PPI and the AIC, a primary account number (PAN) associated with an account; send an authorisation request including the PIN and the PAN to an issuer server associated with the PAN; receive an authorisation approval from the issuer server; and send a transaction approval to the electronic device based on the authorisation approval.

In a final aspect, there is provided at least one non-transitory computer-readable storage media having computer-executable instructions embodied thereon for authorising transactions, wherein when executed by at least one processor, the computer-executable instructions cause the processor to: receive, from an electronic device, a transaction request, the transaction request including predetermined personal information (PPI), an account identification code (AIC), and a personal identification number (PIN); identify, based on the PPI and the AIC, a primary account number (PAN) associated with an account; send an authorisation request including the PIN and the PAN to an issuer server associated with the PAN; receive an authorisation approval from the issuer server; and send a transaction approval to the electronic device based on the authorisation approval.

### BRIEF DESCRIPTION OF THE DRAWINGS

Some embodiments of the present invention are hereinafter further described, by way of example only, with reference to the accompanying drawings, in which:

FIG. 1 is a schematic diagram of one example of a system for authorising transactions;

FIG. 2 is a flow chart of an example of a method for authorising transactions;

FIGS. 3A and 3B are examples of contents of a transaction request;

FIG. 4 is an example of a DOB-AIC-PAN table;

FIG. 5 is a schematic diagram of another example of the system for authorising transactions;

FIG. 6 is an exemplary flow chart of the working process of a terminal device 110 in the system FIG. 1;

FIG. 7 is a schematic diagram of an example of a payment network server in the system of FIG. 1;

FIG. 8 is a schematic diagram of an example of an acquirer server in the system of FIG. 1;

FIG. 9 is a schematic diagram of a example of the terminal device in the system of FIG. 1;

FIG. 10 is a schematic diagram of another example of the terminal device in the system of FIG. 1; and

FIG. 11 is a schematic diagram of an example of an issuer server in the system of FIG. 1.

### DETAILED DESCRIPTION

In this disclosure, the term “user” is intended to refer to a person or entity wishing to conduct a transaction using a financial account. The transaction may be conducted at a terminal device, such as an automated teller machine (ATM) or a point-of-sale (POS) machine. The user may also be referred to as the “card-holder” or the “account-holder”.

The term “user account” is intended to refer to a financial account used by the user in the transaction.

The term “card”, also referred to as “financial card”, is intended to include various cards issued by banks and other financial institutions that can be used to perform transactions, including but not limited to debit cards, credit cards, and other suitable payment cards.

The term “transaction” is intended to include various financial transactions that are associated with user accounts and that can be conducted through a terminal device such as an ATM or a POS machine, including but not limited to cash withdrawal, cash deposit, fund transfer, bill or fee payment, and account balance check. A transaction without using a physical card may also be referred to as a “card-less transaction” or “card not present transaction”. A transaction requiring a physical card to be used may also be referred to as a “card-using transaction” or “card present transaction”.

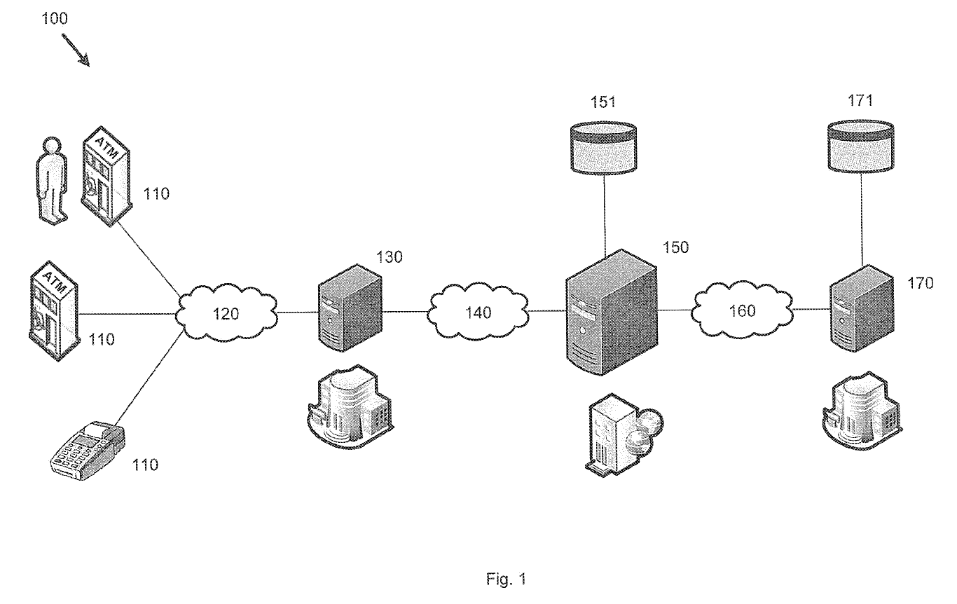

An example of a system 100 for authorising transactions will now be described with reference to FIG. 1.

Transactions associated with a user's at least one financial account may be conducted at any of one or more terminal devices 110, such as ATMs and/or POS machines. The one or more terminal devices 110 are in communication with, via a communication network 120, an acquirer server 130, which in turn communicates with a payment network server 150 via a communication network 140.

The acquirer server 130 is associated with a financial institution that owns or operates the terminal device 110 through which the transaction is conducted. This financial institution may be referred to as the “acquirer”, “acquiring bank”, or “merchant's bank”. In a payment system, the acquirer server 130 may also be referred to as the “acquirer switch”.

The payment network server 150 is associated with a payment network service provider that owns or operates the payment network, such as MasterCard, Visa, American Express, etc.

Further, via a communication network 160, the payment network server 150 is in communication with an issuer server 170 associated with a financial institution that has issued the financial account used in the transaction. This financial institution may be referred to as the “issuer” of the financial account. In a payment system, the issuer server 170 may also be referred to as the “issuer switch” or “issuer processor”.

Further, as shown in FIG. 1, the payment network server 150 may be in communication with at least one local or remote data store 151. The issuer server 170 may be in communication with at least one local or remote data store 171.

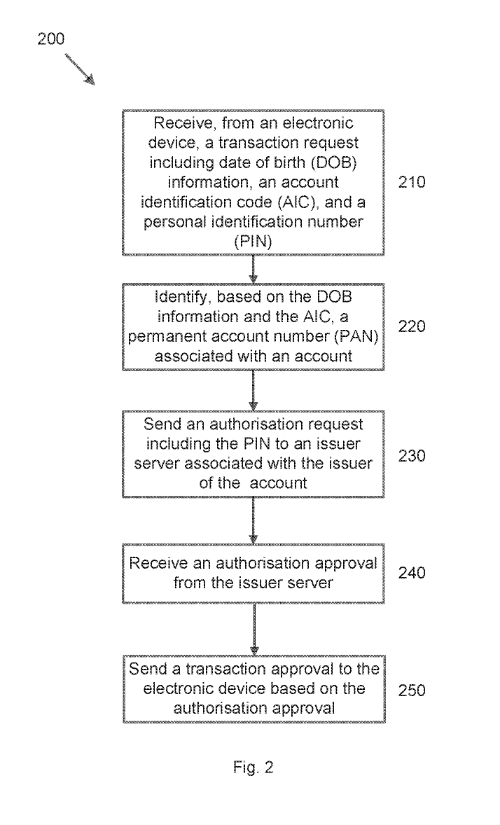

An example of a computer-implemented method 200 for authorising transactions will now be described with reference to FIG. 2.

In the exemplary process described as follows, the method 200 is performed at least in part using one or more electronic processing devices forming part of the system 100 of FIG. 1.

The one or more electronic processing devices may include at least part of the payment network server 150.

Alternatively, in some other examples, the one or more electronic processing devices may include at least part of the acquirer server 130. Alternatively, in some further examples, the one or more electronic processing devices may include at least part of the acquirer server 130, and at least part of the payment network server 150.

As shown in FIG. 2, at Step 210 the one or more electronic processing devices receive, from an electronic device, a transaction request, the transaction request including date of birth (DOB) information, an account identification code (AIC), and a personal identification number (PIN).

The DOB information, the AIC, and the PIN may be obtained through user input at the terminal device 110 (e.g., an ATM or a POS machine) used for an associated transaction.

In this example, the one or more electronic processing devices include the payment network server 150, and the electronic device from which the transaction request is received is the acquirer server 130.

The DOB information, the AIC and the PIN may be obtained by the terminal device 110, and sent to the acquirer server 130. After receiving the DOB information, the AIC and the PIN, the acquirer server 130 may send a transaction request to the payment network server 150.

The DOB information represents the date of birth of the user. It may be in any suitable form, including eight digits representing DDMMYYYY (i.e., the first two digits represent the day of birth, the next two digits represent the month of birth, and the last four digits represent the year of birth). Alternatively, the DOB information may be in the form of YYYYMMDD, or MMDDYYYY. Alternatively, the DOB information may include six digits, for example in the form of DDMMYY, YYMMDD, or MMDDYY.

The AIC is a unique code associated with the user account, allocated to the user by the issuer of the account or the payment network service provider.

The AIC may be numerical, for example, a three-digit number or a four-digit number.

Alternatively, the AIC may be in a series of alphabet letters, or a combination of alphanumeric characters. For example, the AIC may contain three or four letters, or two or three alphanumeric characters.

The AIC may be a longer code (e.g., five or more digits) to allow higher security of the AIC. However, a shorter AIC may be easier for the user to remember, as long as the length of the AIC allows sufficient combinations of numbers, letters or characters to distinguish each user account from all the other user accounts accommodated by the system 100.

The PIN is a password for authenticating the identity of the user. The PIN may be numeric, for example in four digits or six digits. Alternatively, the PIN may include more digits, or be a combination of alphabetic or alphanumeric characters.

The DOB information, the AIC and the PIN may be obtained by the terminal device 110 through user input, for example through one or more inputting devices of the terminal device 110, such as an encrypted PIN pad, a keyboard, or soft keys displayed on a touchscreen.

As described hereinafter, the DOB information may be recorded in an electronic journal (EJ) maintained by the terminal device 100 or the acquirer server 130, for example by capturing and storing an EJ picture (or image) of the screen that displays the DOB information input by the user. This EJ picture denotes an image(s) captured of the user at the transaction juncture and is stored in electronic memory for management of the transaction. The EJ picture may be usable for reconciliation of the transaction juncture.

The DOB information, the AIC and the PIN may be sent from the terminal device 110 to the acquirer 130 through a standard messaging interface, such as an industry-standard message interface, e.g., the International Organization for Standardization (ISO) 8583, or Interactive Financial eXchange (IFX); or a proprietary message interface, e.g., the NCR Direct Connect (NDC) message interface from NCR Corporation, or the 91x message interface provided by Diebold, Inc. For example, under ISO8583, the PIN may be sent through the ISO-defined data elements DE52, and the DOB information and the AIC may be sent through one or more of the ISO-defined data elements DE61, DE62 and DE63.

The transaction request sent from the acquirer server 130 to the payment network server 150 may also be sent through a standard messaging interface, such as the International Organization for Standardization (ISO) 8583, NDC, 91x and the like.

As shown in FIG. 3A, an example transaction request 300 sent from the acquirer server 130 to the payment network server 150 includes a field 310 with data representing the DOB information, a field 320 with data representing the AIC, and a field 330 with data representing the PIN.

The example transaction request 300 may further include a field 340 with data representing details of the transaction, such as transaction type (e.g., cash withdrawal, cash deposit, or bill/fee payment), transaction amount, transaction date/time, and identification information of the ATM or the POS machine used for the transaction. The data fields 310, 320, 330 and 340 may be formed in a different sequence from the example shown in FIG. 3A. Further, in addition to these data fields, the example transaction request 300 may include additional data fields representing other suitable information.

In the above embodiment, the transaction request includes the DOB information. Alternatively, the transaction request may include other suitable information associated with the user instead of the DOB information.

For example, in some embodiments, the transaction request may include predetermined personal information (PPI), the AIC, and the PIN. The PPI may include any suitable type of personal information of the user that distinguishes the user from other individuals, for example, the user's full name, passport number, national ID number, home address, or phone number.

However, as the DOB information is generally more stable, easier to remember, and usually less complicated and shorter compared to other types of personal information, using DOB information may make the inputting process quicker and simpler, and may also reduce the chance of wrong input or failure to input. Further, as some ATMs or POS machines do not include input devices for inputting alphabetic letters, using DOB information, which may only include numbers, may allow the input of the information to be performed without requiring adding extra hardware components to the ATMs or POS machines.

As shown in FIG. 3B, another example transaction request 300 sent from the acquirer server 130 to the payment network server 150 includes a field 350 with data representing the PPI, a field 320 with data representing the AIC, and a field 330 with data representing the PIN.

Similarly, the example transaction request 300 shown in FIG. 3B may further include a field 340 with data representing details of the transaction, such as transaction type (e.g., cash withdrawal, cash deposit, or bill/fee payment), transaction amount, transaction date/time, and identification information of the ATM or the POS machine used for the transaction. The data fields 350, 320, 330 and 340 may be formed in a different sequence from the example shown in FIG. 3B. Further, in addition to these data fields, the example transaction request 300 may include additional data fields representing other suitable information.

Next, at Step 220, the one or more electronic processing devices identify, based on the DOB information and the AIC, a primary account number (PAN) associated with an account.

As described hereinbefore, in this example, the one or more electronic processing devices are the payment network server 150.

Upon receiving the transaction request from the acquirer server 130, the payment network server 150 determines the DOB information and the AIC included in the transaction request, and identifies, based on the DOB information and the AIC, the user account requested to be used by the user for conducting the transaction. The payment network server 150 determines this account by identifying the primary account number (PAN) associated with the account.

This identification step 220 may be conducted by accessing a database storing corresponding relationships between: (i) a plurality of combinations of DOB information and AICs and (ii) a corresponding plurality of PANs. For example, a DOB-AIC-PAN table may be stored in the local or remote data store 151 with which the payment network server 150 is in communication.

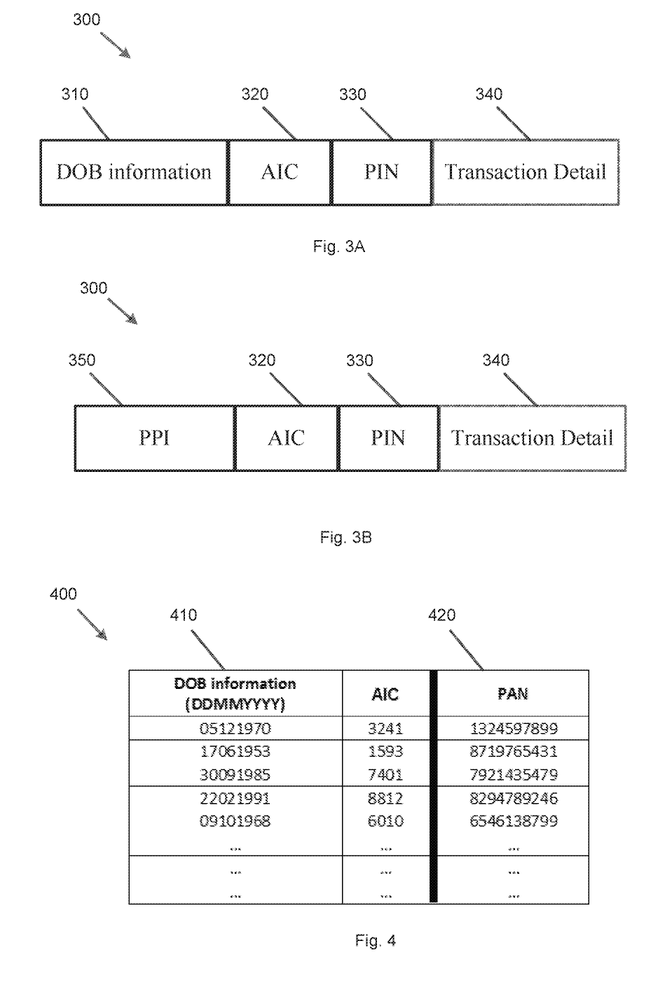

As shown in FIG. 4, an exemplary DOB-AIC-PAN table 400 includes: a data field 410, including a plurality of combinations of the DOB information and the AICs; and a data field 420, including a plurality of PANs, each corresponding to a unique combination of DOB information and an AIC.

The DOB information and the AIC is determined based on the received transaction request, and the payment network server 150 accesses the DOB-AIC-PAN table 400 to identify the corresponding PAN. For example, if the DOB information and the AIC included in the received transaction request are “17061953” (i.e., the user is born on 17 Jun. 1953) and “1593” respectively, by accessing the DOB-AIC-PAN table 400, the payment network server 150 identifies that the corresponding PAN is “8719765431”.

As described hereinbefore, in some embodiments, the transaction request may include predetermined personal information (PPI) instead of DOB information, wherein the PPI may include, e.g., the user's full name, passport number, national ID number, home address, or phone number. Accordingly, instead of the DOB-AIC-PAN table, a PPI-AIC-PAN table may be stored in the local or remote data store 151, and the payment network server 150 accesses the PPI-AIC-PAN table, instead of the DOB-AIC-PAN table, to identify the corresponding PAN.

At Step 230, the one or more electronic processing devices send an authorisation request including the PIN and the PAN to an issuer server associated with the PAN.

Based on the PAN identified in Step 220, the one or more electronic processing devices (e.g., the payment network server 150) determine the issuer associated with the PAN, and then send the authorisation request including the PIN and the PAN to the issuer server 170 associated with that issuer.

In addition to the PIN and the PAN, the authorisation request may further include details of the transaction retrieved from the transaction request, e.g., the transaction type (e.g., cash withdraw, cash deposit, or bill/fee payment), the transaction amount, the transaction date/time, etc.

The authorisation request may be sent to the issuer server 170 through a standard messaging interface, such as the International Organization for Standardization (ISO) 8583.

Next, at Step 240, the one or more electronic processing devices receive authorisation an approval from the issuer server.

When the authorisation request is sent to the issuer server 170, the issuer server 170 determines whether to approve the authorisation based on the information included in the authorisation request, and on relevant information stored in the local or remote data store 171, with which the issuer server 170 is in communication.

For example, the PANs and the corresponding PINs of all the financial accounts issued by the issuer may be stored in the data store 171. By accessing the data store 171, the issuer server 170 may determine whether the received PAN is a valid PAN issued by the issuer, and whether the PIN is the correct PIN associated with that PAN.

If the verification is successful, the issuer server 170 may determine whether the transaction should be allowed, for example based on the transaction amount included in the authorisation request and the balance of the account information associated with the PAN, where the balance of the account information may be retrieved from the data store 171.

If the issuer server 170 determines that the transaction is allowable, the issuer server 170 may send an authorisation approval, approving the transaction, to the payment network server 150.

If the issuer server 170 determines that the PAN is not a valid PAN issued by the issuer associated with the issuer server 170, that the PIN is not the correct PIN associated with the PAN, or that the transaction should not be allowed (e.g., if the balance of the account is less than the requested cash withdrawal amount, or that the cash withdrawal amount exceeds a predetermined withdrawal threshold), the issuer server 170 may reject the authorisation request, for example by sending an authorisation rejecting message to the payment network server 150.

The authorisation approval and the authorisation rejecting message may be sent through a standard messaging interface, such as the International Organization for Standardization (ISO) 8583.

Finally, at Step 250, the one or more electronic processing devices send a transaction approval to the electronic device based on the authorisation approval.

Upon receiving the authorisation approval from the issuer server 170, the one or more electronic processing devices (e.g., the payment network server 150) send a transaction approval to the acquirer server 130.

The acquirer server 130 may then route the transaction approval to the terminal device 110 (i.e., the ATM or the POS machine) from which the transaction is requested. Accordingly, the terminal device 110 may allow the transaction to be conducted.

If the authorisation is rejected by the issuer, the payment network server 150 may receive an authorisation rejecting message from the issuer server 170, and may then send a transaction rejecting message to the acquirer server 130. The acquirer server 130 may route the transaction rejecting message to the terminal device 110, which may in turn reject the transaction and notify the user that the transaction request is rejected.

In the method steps described hereinbefore, the one or more electronic processing devices performing the Steps 210 to 250 are the payment network server 150, and the electronic device from which the transaction request is received is the acquirer server 130.

Alternatively, as mentioned hereinbefore, the one or more electronic processing devices performing the Steps 210 to 250 may include at least part of the acquirer server 130. Accordingly, the electronic device from which the transaction request is received may be the terminal device 110 (e.g., an ATM or a POS machine) at which the transaction is conducted.

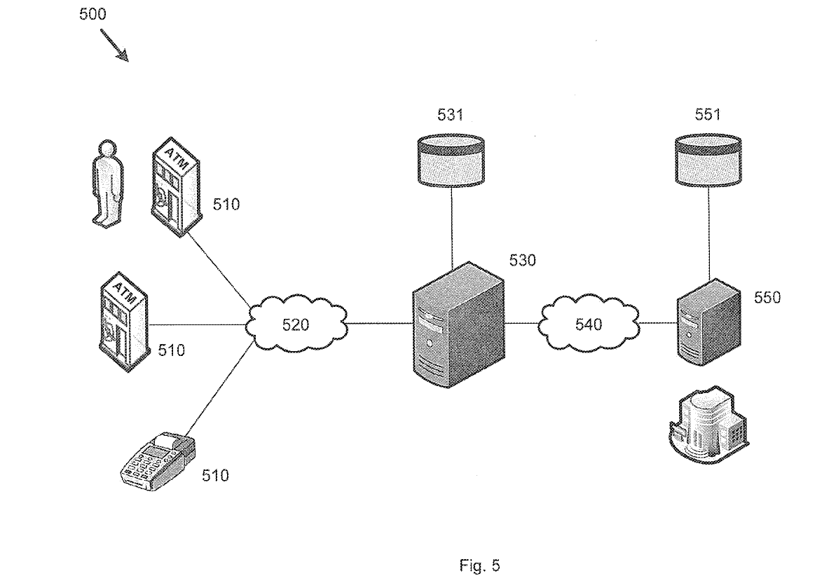

In the system 500 for authorising transactions, as shown in FIG. 5, transactions in relation to a user's at least one financial account may be conducted at any of one or more terminal devices 510, including ATMs and/or POS machines. The one or more terminal devices 510 are in communication with, via a communication network 520, a server 530 including one or more electronic processing devices. The server 530 in turn communicates with an issuer server 550 via a communication network 540.

Further, the server 530 may be in communication with at least one local or remote data store 531. The issuer server 550 may be in communication with at least one local or remote data store 551.

The above-described method 200 for authorising transactions including Steps 210-250 may be performed by the server 530, wherein the transaction request is received, via the communication network 520, from the terminal device 510 (e.g., an ATM or a POS machine) at which the transaction is conducted.

It will be appreciated that according to at least one embodiment, the above-described process may provide a number of advantages. For example, a simple and convenient method of authorising transactions without using a physical payment card may be provided. The method may prevent or reduce the trouble and insecurity of carrying a payment card. The method may also allow a user to simply use a combination of: (i) a relatively longer piece of information that is easier to be remembered (e.g., the DOB information or the PPI); (ii) a relatively shorter piece of information that is more difficult to be remembered (e.g., the AIC); and (iii) the PIN, instead of using the PAN, which is typically a long number that is difficult to remember.

The described method may significantly reduce the effort required for a user to remember authentication information associated with a financial account, and may efficiently prevent or reduce the possibility of incorrect input or of failure to provide the authentication information when a user is using an ATM or a POS machine without a card.

In some ATMs or POS machines, the operation of the ATM or the POS machine may be controlled by the acquirer server 130. Accordingly, the described method may require only limited modification to the payment network server and the acquirer server 130, without requiring substantial modification to the existing ATMs or the POS machines. The computer-implemented method 200 for authorising transactions may further include recording the transaction request, the PAN, and the authorisation approval.

The transaction request, the PAN, and the authorisation approval may be recorded in a payment network electronic journal maintained by the payment network server 150. The payment network electronic journal may be stored in the at least one local or remote data store 151.

The DOB information or the PPI, the AIC, and the PIN, together with details of the transaction (e.g., the details of transaction described hereinbefore), may be recorded in an ATM or POS machine electronic journal stored in the ATM or the POS machine at which the transaction is conducted, or in an acquirer journal maintained by the acquirer server 130. The electronic journal may include images generated by capturing the screen that displays the DOB information or the PPI input by the user. This may be used for reconciliation. Further, in some embodiments, the computer-implemented method 200 for authorising transactions may further include sending the identified PAN to the electronic device.

For example, when the computer-implemented method 200 is executed by the payment network server 150, the identified PAN may be sent to the acquirer server 130. The identified PAN may subsequently be used by the acquirer for reconciliation. For example, the identified PAN may be sent to the acquirer server 130 through the T464/461 files in a MasterCard single message system.

Further, in some embodiments, the computer-implemented method 200 for authorising transactions may further include: receiving user input information representing user input at a terminal device; and determining whether to enter a card-less transaction mode based on the user input information.

As described hereinbefore, the transaction may be conducted at a terminal device 110, such as an ATM or a POS machine, without using a physical payment card.

In some embodiments, the ATM or the POS machine at which the transaction is conducted may also be able to perform transactions using physical payment cards. That is, the ATM or the POS machine may include two transaction modes: (i) a card-using mode for performing card-using transactions, and (ii) a card-less mode for performing card-less transactions. Accordingly, when using the ATM or the POS machine, the user may be allowed to select a card-using mode or a card-less mode.

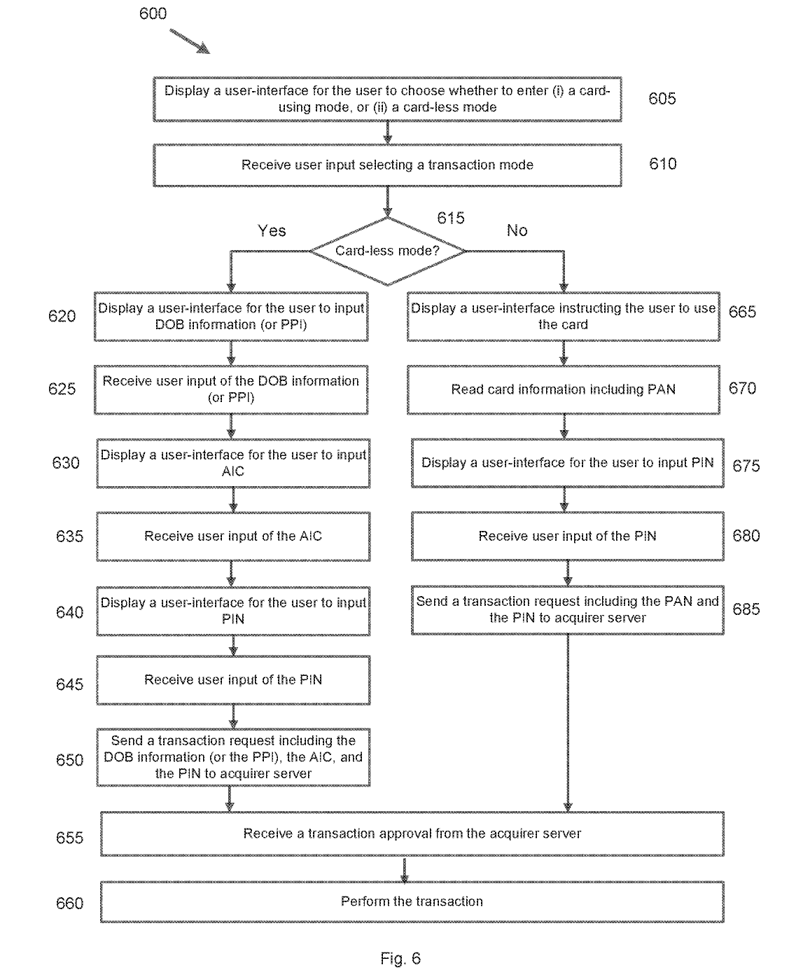

As shown in FIG. 6, in an exemplary working flow 600 of a terminal device 110 (e.g., an ATM or a POS machine) that has both the card-using mode and the card-less mode, at Step 605, the terminal device 110 displays a user-interface for the user to choose whether to enter a card-using mode or a card-less mode.

At Step 610, the terminal device 110 receives user input, the user input indicating whether the card-using mode or the card-less mode is selected by the user.

The user input may be received by any suitable means. For example, two soft keys, representing the card-using mode and the card-less mode respectively, may be displayed on a touchscreen of the terminal device 110. Accordingly, the user may touch, tap or press one of the two soft keys to choose the card-using mode or the card-less mode.

Alternatively, instructions may be displayed on a screen of the terminal device 110, indicating that the user may press a first hardware key of the terminal device 110 to choose a card-using mode, or press a second hardware key of the terminal device 110 to choose a card-less mode. The first hardware key and the second hardware key may be, for example, function keys (which may also be referred to as “function defined keys”, or FDKs), keys on a hardware keyboard or on an encrypted PIN pad of the terminal device 110.

Alternatively, the card-using mode may be triggered by the user present a physical card at a card-reading device of the terminal device 110, for example, by inserting the card into a card slot, swiping the card through a card-reader, or tapping or presenting the card on a Near Field Communication (NFC) card-reading device. Payment devices with a non-card form factor, such as a payment-enabled smart phone or a contactless fob, may also be used to initiate payment at the terminal device 110.

Next, at Step 615, the terminal device 110 determines whether the card-using mode or the card-less mode is chosen by the user based on the user input.

If the card-less mode is selected by the user, the terminal device 110 proceeds to Step 620, displaying a user-interface for the user to input the DOB information (or the PPI). The user input of the DOB information (or the PPI) is received at Step 625.

Next, the terminal device 110 displays a user-interface at Step 630 for the user to input the AIC. The user input of the AIC is received at Step 635.

Further, the terminal device 110 displays a user-interface at Step 640 for the user to input the PIN. The user input of the PIN is received at Step 645.

Next, at Step 650, the terminal device 110 sends a transaction request to the acquirer server 130 associated with the terminal device 110, the transaction request including the DOB information (or the PPI), the AIC, and the PIN.

As described hereinbefore, the acquirer server 130 may route the DOB information (or the PPI), the AIC, and the PIN to the payment network server 150, where the PAN is identified based on the DOB information (or the PPI) and the AIC. The payment network server 150 may then send an authorisation request including the PIN and the PAN to an issuer server 170 associated with the PAN, and subsequently receives an authorisation approval from the issuer server 170. The payment network server 150 may then send a transaction approval to acquirer server 130 based on the authorisation approval, which may in turn route the transaction approval to the terminal device 110. The transaction approval is received by the terminal device 110 at Step 655. Upon receiving the transaction approval, the terminal device 110 proceeds to Step 660 to perform the transaction.

If at Step 615 it is determined that the card-using mode is selected by the user, the terminal device 110 may display a user-interface, instructing the user to use the physical card or other payment device, for example, to insert the card into a card slot, swipe the card through a card-reader, or tap or present the card or other payment device on a Near Field Communication (NFC) card-reading device.

At Step 670, card information including the PAN of the card is obtained by the terminal device 110 through the card-reading device.

Next, the terminal device 110 displays a user-interface at Step 675 for the user to input the PIN. The user input of the PIN is received at Step 680.

The terminal device 110 then sends a transaction request including the PAN and the PIN to an acquirer server 130 associated with the terminal device 110, which may subsequently route the PAN and the PIN to a payment network server 150. Based on the PAN, the payment network server 150 may then sends an authorisation request including the PIN and the PAN to an issuer server 170 associated with the PAN, and subsequently receives an authorisation approval from the issuer server 170. Based on the authorisation approval, the payment network server 150 may then send a transaction approval to the acquirer server 130, which may in turn route the transaction approval to the terminal device 110. The transaction approval is received by the terminal device 110 at Step 655. Upon receiving the transaction approval, the terminal device 110 proceeds to Step 660 to perform the transaction.

Further, although not illustrated in FIG. 6, the terminal device 110 may require the user to input details of the transaction, and send the received transaction details to the acquirer server 130 as described hereinbefore.

The systems 100 and 500 described hereinabove may be single message payment systems, in which the authorisation and clearing are performed in one dispatch, and all the information necessary to post the transaction to the cardholder's account is communicated at the time of each transaction. Alternatively, the methods for authorising transactions described hereinbefore may be used in a dual-message system, in which the authorised transactions are submitted to the acquirer in a batches rather than individual transactions.

Referring back to FIG. 1, in practice, the communications networks 120, 140 and 160 in FIG. 1 may take any appropriate form, such as the Internet and/or one or a number of local area networks (LANs). In practice, the various devices and data stores may communicate via any appropriate mechanism, such as via wired or wireless connections, including, but not limited to mobile networks, private networks, such as an 802.11 network, the Internet, LANs, WANs, as well as via direct or point-to-point connections, such as Bluetooth.

In practice, the communications networks 120, 140 and 160 shown in FIG. 1 may be different networks, each providing connectivity between the terminal devices 110, the acquirer server 130, the payment network server 150, and the issuer server 170, respectively. Alternatively, the communications networks 120, 140 and 160 may be a single network that provides onward connectivity to the terminal devices 110, the acquirer server 130, the payment network server 150, and the issuer server 170.

The system 100 may include multiple terminal devices 110 in numerous geographic locations around a country or region.

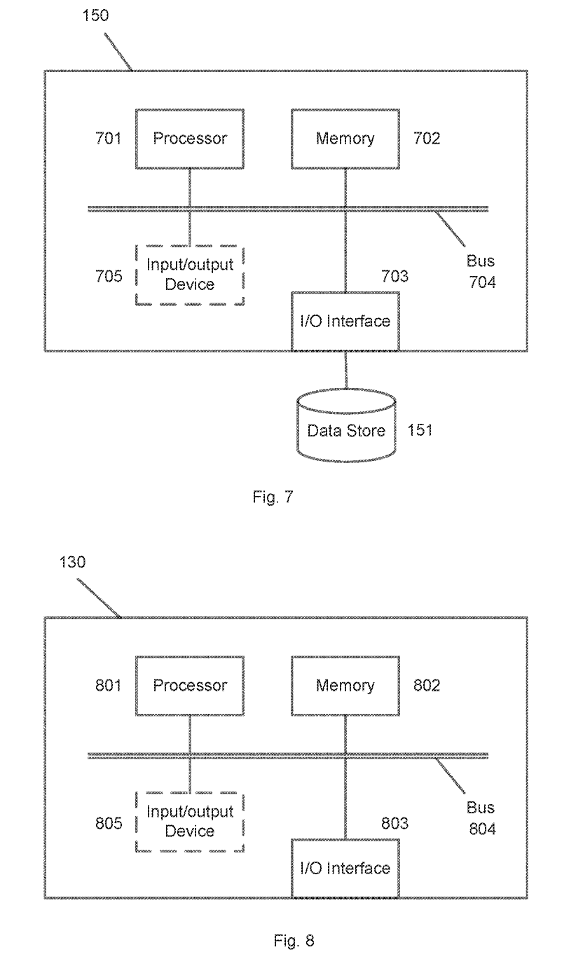

As shown in FIG. 7, an example of the payment network server 150 may include at least one processor 701, a memory 702, and an external input/output interface 703, interconnected via a bus 704. In some examples, the payment network server 150 may additionally include an input/output device 705, such as a keyboard and/or a display. In this example, the external interface 703 can connect the payment network server 150 to peripheral devices and/or networks, such as the communications networks 140 and 160, data store 151, and/or other storage devices. Although a single external interface 703 is shown, this is for the purpose of example only, and in practice multiple interfaces using different communication protocols (e.g. Ethernet, serial, USB, wireless) may be provided.

In use, the processor 701 executes machine-readable instructions stored in the memory 702 to perform the method described herein, including communicating with the acquirer server 130, the issuer server 170 and the data stores 151, e.g., receiving a transaction request from the acquirer server 130, identifying a PAN associated with an account based on the DOB information (or the PPI) and the AIC included in the transaction request, sending an authorisation request including the PIN and the PAN to the issuer server 170, receiving an authorisation approval from the issuer server 170, and sending a transaction approval to the acquirer server 130 based on the authorisation approval. The machine-readable instructions may include one or more software modules, and may be executed in a suitable execution environment, such as an operating system environment.

Accordingly, it will be appreciated that the payment network server 150 may be formed from any suitable processing system, such as a computer system, PC, web server, or network server. The machine-readable instructions can be embodied in non-transitory computer-readable storage media, e.g., a hard drive.

As shown in FIG. 8, an example of the acquirer server 130 includes at least one processor 801, a memory 802, and an external input/output interface 803, interconnected via a bus 804. In some examples, the acquirer server 130 may additionally include an input/output device 805, such as a keyboard and/or a display. In this example, the external interface 803 can connect the acquirer server 130 to peripheral devices and/or networks, such as the communications networks 120 and 140, and/or additional local or remote storage devices. Although a single external interface 803 is shown, this is for the purpose of example only, and in practice multiple interfaces using different communication protocols (e.g. Ethernet, serial, USB, or wireless) may be provided.

In use, the processor 801 executes machine-readable instructions stored in the memory 802 to perform the method described herein, including communicating with the terminal devices 110 and the payment network server 150, such as routing the transaction request and the transaction approval. The machine-readable instructions may include one or more software modules, and may be executed in a suitable execution environment, such as an operating system environment.

Accordingly, it will be appreciated that the acquirer server 130 may be formed from any suitable processing system, such as a suitably programmed computer system, PC, web server, or network server. The machine-readable instructions can be embodied in non-transitory computer-readable storage media.

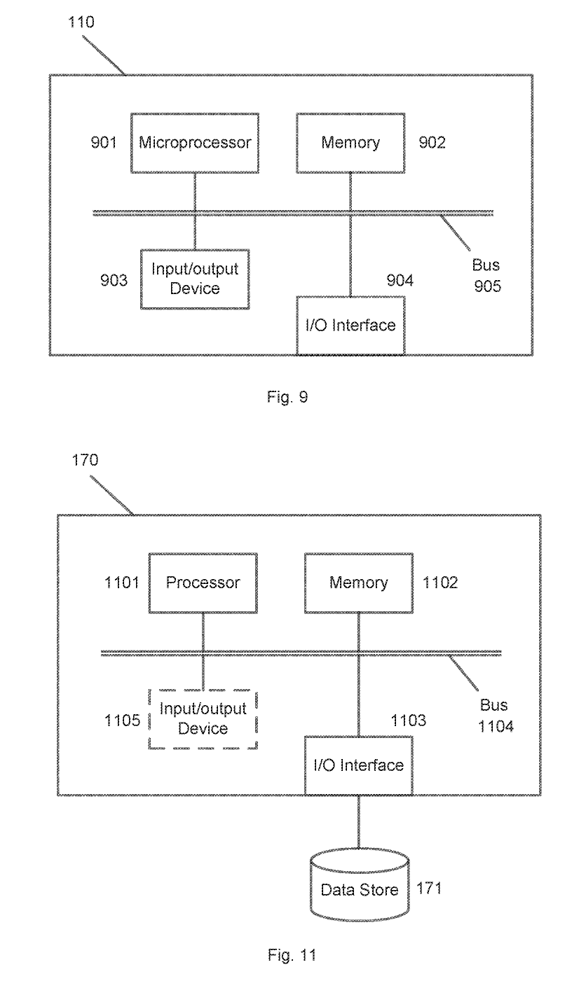

As shown in FIG. 9, an example of the terminal device 110 may include at least one microprocessor 901, a memory 902, an input/output device 903, such as a keyboard and/or display, and an external input/output interface 904, interconnected via a bus 405. In this example, the external interface 904 can connect the terminal device 110 to peripheral devices and/or networks, such as the communications network 120, and/or additional local or remote data storage devices. Although a single external interface 904 is shown, this is for the purpose of example only, and in practice multiple interfaces using different communication protocols (e.g. Ethernet, serial, USB, or wireless) may be provided.

In use, the microprocessor 901 executes machine-readable instructions stored in the memory 902 to allow communication with the acquirer server 130, for example to send a transaction request via the input/output interface 904, and to allow displaying a graphical user interface and receiving user input via the input/output device 903. The machine-readable instructions may include one or more software modules, and may be executed in a suitable execution environment, such as an operating system environment.

As described hereinbefore, the terminal devices 110 may be an ATM or a POS machine.

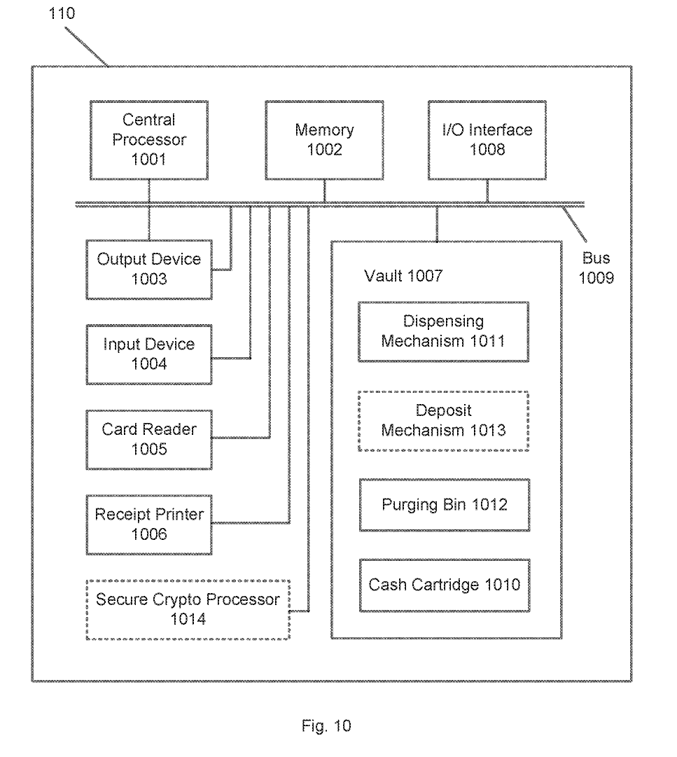

As shown in FIG. 10, an example of the ATM may include at least a central processor 1001, a memory 1002, an output device 1003 such as a display, an input device 1004 such as function key buttons, an encrypted PIN pad, and/or a keypad, at least one card reader 1005 (e.g., a magnetic or chip card reader), a receipt printer 1006, a vault 1007, and an external input/output interface 1008 that may include a network hardware device such as a modem (e.g., dial-up or ADSL), interconnected via a bus 1009. The vault 1007 may include a cash cartridge 1010 (which may also be referred to as a “cash cassette” or “currency cassette”), a dispensing mechanism 1011 and a purge bin 1012, and may further include a deposit mechanism 1013. It will also be understood that the ATM may further include any other suitable component, such as a secure crypto processor 1014, and/or additional sensors and/or indicators.

As shown in FIG. 11, an example of the issuer server 170 includes at least one processor 1101, a memory 1102, and an external input/output interface 1103, interconnected via a bus 1104. In some examples, the issuer server 170 may additionally include an input/output device 1105, such as a keyboard and/or a display. In this example, the external interface 1103 can be utilised for connecting the issuer server 170 to peripheral devices and/or networks, such as the communications network 160, data store 171, and/or other storage devices. Although a single external interface 1103 is shown, this is for the purpose of example only, and in practice multiple interfaces using different communication protocols (e.g. Ethernet, serial, USB, or wireless) may be provided.

In use, the processor 1101 executes machine-readable instructions stored in the memory 1102 to allow communication with the payment network server 150, for example receiving an authorisation request from the payment network server 150, and sending an authorisation approval to the payment network server 150. The machine-readable instructions may include one or more software modules, and may be executed in a suitable execution environment, such as an operating system environment. It will be appreciated that the issuer server 170 may be formed from any suitable processing system, such as a suitably programmed computer system, PC, web server, or network server. The machine-readable instructions can be embodied in non-transitory computer-readable storage media.

In addition, also described herein is one or more non-transitory computer-readable storage media having computer-executable instructions embodied thereon for authorising transactions, wherein, when executed by at least one processor, the computer-executable instructions cause the processor to:
receive, from an electronic device, a transaction request, the transaction request including date of birth (DOB) information, an account identification code (AIC), and a personal identification number (PIN);
identify a primary account number (PAN) associated with an account based on the DOB information and the AIC;
send an authorisation request including the PIN and the PAN to an issuer server associated with the PAN;
receive an authorisation approval from the issuer server; and
send a transaction approval to the electronic device based on the authorisation approval.

In addition, also described herein is at least one non-transitory computer-readable storage media having computer-executable instructions embodied thereon for authorising transactions, wherein when executed by at least one processor, the computer-executable instructions cause the processor to:
receive, from an electronic device, a transaction request, the transaction request including predetermined personal information (PPI), an account identification code (AIC), and a personal identification number (PIN);
identify a primary account number (PAN) associated with an account based on the PPI and the AIC;
send an authorisation request including the PIN and the PAN to an issuer server associated with the PAN;
receive an authorisation approval from the issuer server; and
send a transaction approval to the electronic device based on the authorisation approval.

Throughout this specification and claims which follow, unless the context requires otherwise, the word “comprise”, and variations such as “comprises” or “comprising”, will be understood to imply the inclusion of a stated integer or group of integers or steps but not the exclusion of any other integer or group of integers.

Many modifications will be apparent to those skilled in the art without departing from the scope of the present invention.

The claims defining the invention are as follows:

1. A computer-implemented method for authorising transactions, including:
receiving, from an electronic device, a transaction request, the transaction request including date of birth (DOB) information, an account identification code (AIC), and a personal identification number (PIN);
identifying, based on the DOB information and the AIC, a primary account number (PAN) associated with an account;
sending an authorisation request including the PIN and the PAN to an issuer server associated with the PAN;
receiving an authorisation approval from the issuer server; and
sending a transaction approval to the electronic device based on the authorisation approval.

2. The method according to claim 1, wherein the AIC is numerical.

3. The method according to claim 2, wherein the AIC is a three-digit number or a four-digit number.

4. The method according to claim 1, wherein the AIC is a combination of alphanumeric characters.

5. The method according to claim 1, wherein the electronic device is an acquirer server device.

6. The method according to claim 1, wherein the transaction request is associated with a transaction conducted at an automated teller machine (ATM).

7. The method according to claim 1, wherein the transaction request is associated with a transaction conducted at a point-of-sale (POS) machine.

8. The method according to claim 6, wherein the transaction request further includes transaction information representing details of the transaction.

9. The method according to claim 1, further including:
recording the transaction request, the PAN, and the authorisation approval.

10. The method according to claim 1, further including:
sending the identified PAN to the electronic device.

11. The method according to claim 1, further including:
receiving user input information representing user input at a terminal device;
determining whether to enter a card-less transaction mode based on the user input information.

12. A system for authorising transactions, the system including at least one processor configured to:
receive, from an electronic device, a transaction request, the transaction request including date of birth (DOB) information, an account identification code (AIC), and a personal identification number (PIN);
identify, based on the DOB information and the AIC, a primary account number (PAN) associated with an account;
send an authorisation request including the PIN and the PAN to an issuer server associated with the PAN;
receive an authorisation approval from the issuer server; and
send a transaction approval to the electronic device based on the authorisation approval.

13. A computer-implemented method for authorising transactions, including:
receiving, from an electronic device, a transaction request, the transaction request including predetermined personal information (PPI), an account identification code (AIC), and a personal identification number (PIN);
identifying, based on the PPI and the AIC, a primary account number (PAN) associated with an account;
sending an authorisation request including the PIN and the PAN to an issuer server associated with the PAN;
receiving an authorisation approval from the issuer server; and
sending a transaction approval to the electronic device based on the authorisation approval.
